(19) United States
(12) Patent Application Publication
(10) Pub. No.: US 2005/0122406 A1
(43) Pub. Date: Jun. 9, 2005

(54) Digital camera system and method having autocalibrated playback viewing performance

(76) Inventors: James S. Voss, Fort Collins, CO (US); James W. Owens, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/732,870

(22) Filed: Dec. 9, 2003

(51) Int. Cl. H04N 17/00; H04N 17/02

(52) U.S. Cl. 348/222.1; 348/187

(57) ABSTRACT

A system and method embodied in a digital camera coupled to a television that cooperate to calibrate and optimize images displayed on the television. The digital camera is provided with a video output port, an image sensor, a display, a lens and processing circuitry. The digital camera stores a television color bar. The digital camera has autocalibration firmware comprising a user interface that is used to automatically calibrate the video signal sent from the digital camera to the television. The firmware, by way of the user interface, prompts the user to point the camera at the television. The digital camera outputs the color bar by way of the output port to the television, which is displayed. Once pointed at the television, the image sensor views (images) the color bar displayed on the television, and the firmware automatically detects the imaged color bar. The firmware automatically adjusts (calibrates) the video signal output to the television until an optimal displayed image has been achieved.

### TECHNICAL FIELD

The present invention relates generally to digital cameras and methods.

### BACKGROUND

Digital cameras certainly have come of age when it comes to capturing and instantly reviewing photographs. More and more however, digital cameras are often used as a sharing device for showing pictures stored in the camera with friends and family. Many times this is done using a video output port of the camera and a conventional television.

Shop at any major retailer (Wal-Mart, Circuit City, Best Buy, for example) and it is clear no two televisions are the same. As is clear from looking at the large number of televisions that are on display at these stores, colors can vary dramatically, and contrast often times needs adjustment, for example.

In general, conventional televisions vary significantly in terms of color performance, brightness, and contrast, for example. It would be desirable to calibrate out those variances, to the extent possible, when viewing photographs or video stored in a digital camera. There are no know conventional solutions that address this problem.

### SUMMARY OF THE INVENTION

The present invention comprises a system and method having a digital camera that is coupled to a television that cooperate to calibrate and optimize the image displayed on the television. The digital camera comprises a video output port, an image sensor, a display, a lens and processing circuitry. The digital camera stores a television color bar. The digital camera has autocalibration firmware (a software algorithm) comprising a user interface that is used to automatically calibrate the video signal sent from the digital camera to the television so that the television displays the best possible images to a viewer.

The firmware, by way of the user interface, prompts the user to point the camera at the television. The digital camera outputs the color bar by way of the output port to the television, which is displayed. Once pointed at the television, the image sensor views the color bar displayed on the television, and the firmware automatically detects the imaged color bar. The firmware automatically adjusts (calibrates) the video signal output to the television until an optimal displayed image has been achieved.

### BRIEF DESCRIPTION OF THE DRAWINGS

The various features and advantages of embodiments of the present invention may be more readily understood with reference to the following detailed description taken in conjunction with the accompanying drawings, wherein like reference numerals designate like structural elements, and in which:

FIGS. 1a and 1b are rear and front views, respectively, of an exemplary digital camera that may be used in a system in accordance with the principles of the present invention;

FIG. 2 illustrates an exemplary system in accordance with the principles of the present invention; and

FIG. 3 illustrates an exemplary method in accordance with the principles of the present invention.

### DETAILED DESCRIPTION

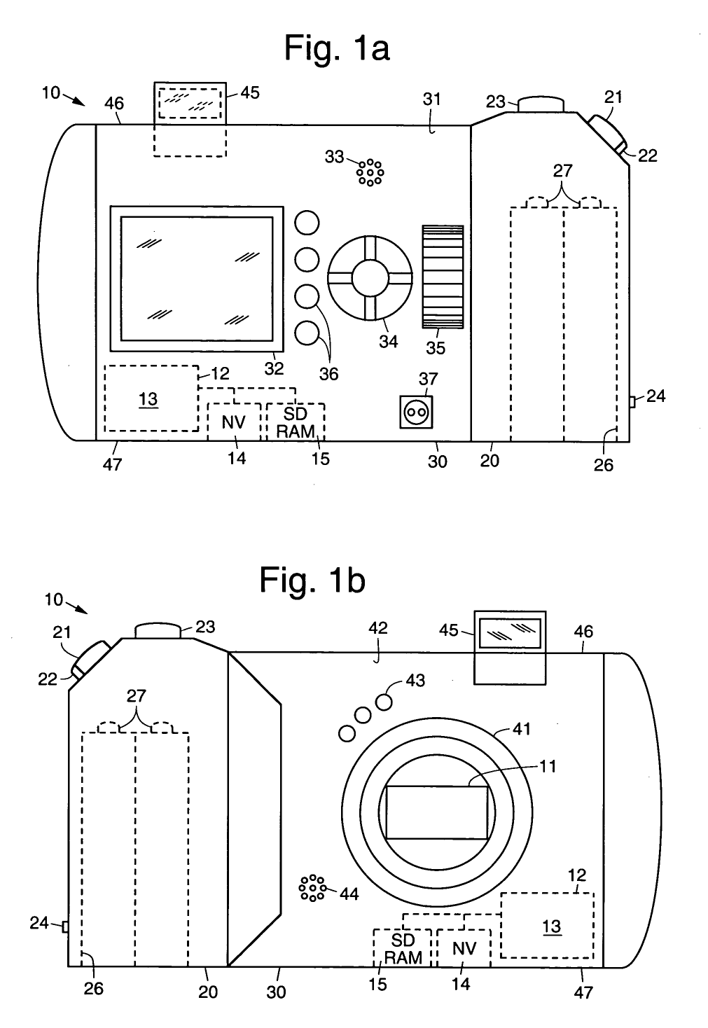

Referring to the drawing figures, FIGS. 1a and 1b are rear and front views, respectively, of an exemplary digital camera 10 implemented in accordance with the principles of the present invention. As is shown in FIGS. 1a and 1b, the exemplary digital camera 10 comprises a handgrip section 20 and a body section 30. The handgrip section 20 includes a power button 21 or switch 21 having a lock latch 22, a record button 23, a strap connection 24, and a battery compartment 26 for housing batteries 27. The batteries may be inserted into the battery compartment 26 through an opening adjacent a bottom surface 47 of the digital camera 10.

As is shown in FIG. 1a, a rear surface 31 of the body section 30 comprises a liquid crystal display (LCD) 32 or viewfinder 32, a rear microphone 33, a joystick pad 34, a zoom control dial 35, a plurality of buttons 36 for setting functions of the camera 10 and a video output port 37 for downloading images to a computer, for example. As is shown in FIG. 1b, a zoom lens 41 extends from a front surface 42 of the digital camera 10. A metering element 43 and front microphone 44 are disposed on the front surface 42 of the digital camera 10. A pop-up flash unit 45 is disposed adjacent a top surface 46 of the digital camera 10.

An image sensor 11 is coupled to processing circuitry 12 (illustrated using dashed lines) that are housed within the body section 30, for example. An exemplary embodiment of the processing circuitry 12 comprises a microcontroller (μC) 12 or central processing unit (CPU) 12. The (μC 12 or CPU 12 is coupled to a nonvolatile (NV) storage device 14, and a high speed (volatile) storage device 15, such as synchronous dynamic random access memory (SDRAM) 15, for example.

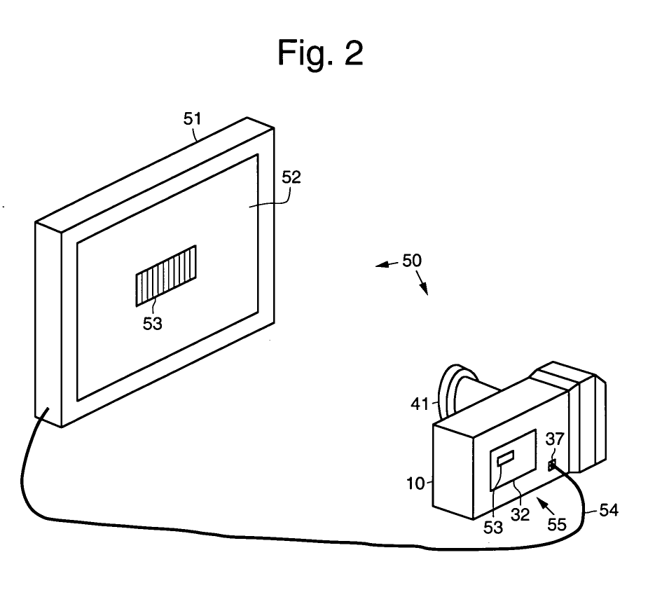

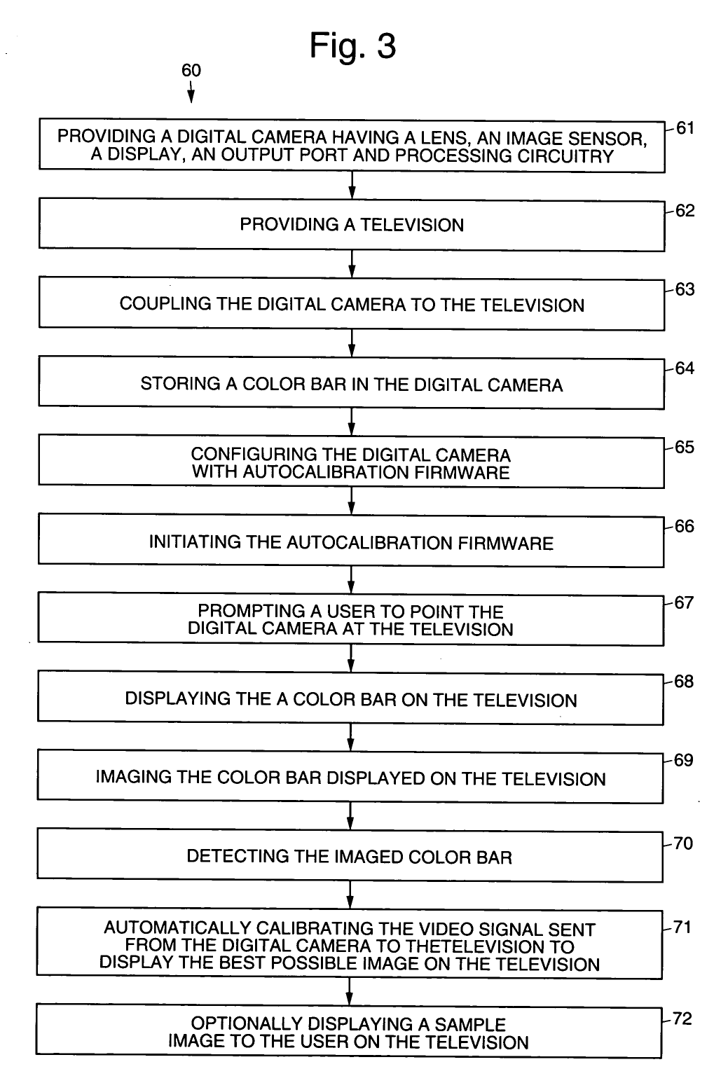

The processing circuitry 12 (microcontroller (μC) 12 or CPU 12) in the digital camera 10, embodies firmware 13 comprising an autocalibration algorithm 13 in accordance with the principles of the present invention. This will be discussed in more detail with reference to FIGS. 2 and 3.

FIG. 2 illustrates an exemplary system 50 in accordance with the principles of the present invention. The exemplary system 50 comprises a digital camera 10, such as the digital camera 10 discussed with reference to FIGS. 1a and 1b, for example, that is coupled to a television 51. The television 51 has a screen 52. The digital camera 10 is coupled to a television 51 by way of a cable 54, such as a coaxial cable or composite video cable, for example.

In accordance with the present invention, the digital camera 10 includes a user interface 55 implemented using the autocalibration firmware 13 (or software algorithm 13) that runs on the processing circuitry 12 (microcontroller (μC) 12 or CPU 12). A standard television color bar 53, which may be a stored image or picture, for example, is stored in the digital camera 10. The television color bar 53 may be stored in the nonvolatile storage device 14, for example.

The autocalibration firmware 13 is designed to automatically calibrate the video signal sent from the digital camera 10 to the television 51 so that the television 51 displays the best possible images to a viewer.

The firmware 13, by way of the user interface 55, prompts the user to point the digital camera 10 at the television 51. The digital camera 10 outputs a color bar 53 by way of the output port 37 to the television 51, which are displayed on the television screen 52. Once pointed at the television 51, the lens 41 and image sensor 11 views the color bar 53 displayed on the television screen 52, and the firmware 13 automatically detects the imaged color bar 53.

The firmware 13 automatically adjusts the video signal output to the television 51 until an optimal displayed image of the color bar 53 has been achieved. This adjustment is described in the next paragraph. When finished with this autocalibration procedure, a sample image (a selected stored picture, for example), may be displayed to the user on the television screen 52 to verify the change from the image displayed prior to autocalibration.

Adjustments in each of the colors is made. Color in the camera 10 is usually stored in an R,G,B pixel value. At some point, this RGB data is converted to TV standard YCbCr data. There are very standard methods for this transformation across the color spaces. During this transformation, data that was obtained from the color-calibration process is used in various ways. For example, if the green color on the TV looks a little to hued, then during the transformation, additional saturation of the green RBG data would be performed before the transformation, or saturation to the green channel would be added while in the YCbCr color space. Doing this directly in YCbCr is a good way to accomplish this because pictures are typically stored in this fashion (a .jpg image is YCbCr). Similarly if the Red color bar appears more yellow or orange than it should, then the same adjustments would be made in the Red channel of every pixel within the image to make each pixel have the value of red that would best be represented on the television 51.

Thus, by using a mechanism such as a color bar 53, for example, and using the lens 41 and sensor 11 of the digital camera 10, autocalibration of the system 50, and in particular, the video signal supplied to the television 51, is achieved to optimize colors, brightness and provide the best picture and video sharing experience possible.

In addition, the video output port 37 of the digital camera 10 causes variances in the displayed image. The present invention calibrates out the television-related variances and also simultaneously calibrates out problems caused by the video output port 37. Generally, the in-camera variances caused by the video output port 37 are minimal or negligible compared to the television-related variances, but they are there none-the-less.

For the purposes of completeness, FIG. 3 illustrates an exemplary method 60 in accordance with the principles of the present invention. The exemplary method 60 comprises the following steps.

A digital camera 10 is provided 61 that comprises a lens 41, an image sensor 11, a display 32, a video output port 37, and processing circuitry 12. A television 51 is provided 62. The digital camera 10 is coupled 63 to a television 51, such as by using its output port 37 and a cable 54, for example. A standard television color bar 53 is stored 64 in the digital camera 10.

The digital camera 10 is configured 65 with autocalibration firmware 13 that runs on the processing circuitry 12. When initiated 66, the autocalibration firmware 13 prompts 67 the user to point the digital camera 10 at the television 51, displays 68 the color bar 53 on the television 51, images 69 the color bar 53 displayed on the television 51 onto the image sensor 11, detects 70 the imaged color bar 53, and automatically calibrates 71 the video signal sent from the digital camera 10 to the television 51 to display the best possible image on the television 51 to a viewer. Optionally, and in addition, a sample image may be displayed 72 to the user on the television 51.

Thus, by using a mechanism such as a color bar, for example, and using the lens and sensor of the digital camera, autocalibration of the video signal is readily achieved to optimize colors, brightness and provide the best picture and video sharing experience possible.

Advantages provided by the present invention are that this solution provides better color reproduction for a given television than any known prior solution that uses the exact same video signal for all televisions.

Thus, digital cameras and methods that provide autocalibration for playback viewing and performance have been disclosed. It is to be understood that the above-described embodiments are merely illustrative of some of the many specific embodiments that represent applications of the principles of the present invention. Clearly, numerous and other arrangements can be readily devised by those skilled in the art without departing from the scope of the invention.

1. A system comprising:
a digital camera that comprises a lens, an image sensor, a display, a video output port, and processing circuitry;
a television color bar is stored in the digital camera;
a television coupled to the digital camera; and
autocalibration firmware that runs on the processing circuitry that displays the color bar on the television, images the color bar displayed on the television, detects the imaged color bar, and automatically calibrates the video signal sent from the digital camera to the television to display the best possible image on the television.

2. The system recited in claim 1 wherein the autocalibration firmware displays a sample image on the television.

3. The system recited in claim 1 wherein the television color bar comprises a stored image.

4. The system recited in claim 1 wherein the digital camera comprises a nonvolatile storage device and the television color bar comprises an image stored in the nonvolatile storage device.

5. The system recited in claim 1 wherein the autocalibration firmware prompts the user to point the digital camera at the television.

6. A method comprising the steps of;
providing a digital camera that comprises a lens, an image sensor, a display, a video output port, processing circuitry, a television color bar and autocalibration firmware stored in the digital camera that runs on the processing circuitry;
providing a television;
coupling the digital camera to the television;
initiating the autocalibration firmware;
displaying the color bar on the television;
imaging the color bar displayed on the television onto the image sensor;
detecting the imaged color bar; and
automatically calibrating the video signal sent from the digital camera to the television to display the best possible image on the television.

7. The method recited in claim 6 further comprising the step of prompting a user to point the digital camera at the television.

8. The method recited in claim 5 further comprising the step of displaying a sample image on the television.

9. A digital camera for use with a television, comprising:
a lens;
an image sensor;
a display;
a video output port for coupling the digital camera to the television;
processing circuitry;
a stored television color bar; and
autocalibration firmware that runs on the processing circuitry that is operative to display the color bar on the television, image the color bar that is displayed on the television, detect the imaged color bar, and automatically calibrate the video signal sent from the digital camera to the television to display the best possible image on the television.

10. The system recited in claim 9 wherein the autocalibration firmware displays a sample image on the television.

11. The system recited in claim 9 wherein the television color bar comprises a stored image.

12. The system recited in claim 9 wherein the digital camera comprises a nonvolatile storage device and the television color bar comprises an image stored in the nonvolatile storage device.

13. The system recited in claim 9 wherein the autocalibration firmware prompts the user to point the digital camera at the television.

14. A method for use with a television, and =digital camera that comprises a lens, an image sensor, a display, a video output port, processing circuitry, a television color bar and autocalibration firmware that runs on the processing circuitry, the method comprising the steps of;
coupling the digital camera to the television;
initiating the autocalibration firmware to display the color bar on the television, image the color bar displayed on the television onto the image sensor, and detect the imaged color bar; and
automatically calibrating the video signal sent from the digital camera to the television to display the best possible image on the television.

15. The method recited in claim 14 further comprising the step of prompting a user to point the digital camera at the television.

16. The method recited in claim 14 further comprising the step of displaying a sample image on the television.
